(19) United States
(12) Patent Application Publication
(10) Pub. No.: US 2018/0201755 A1
(43) Pub. Date: Jul. 19, 2018

(54) IMPACT-MODIFIED POLYCARBONATE COMPOSITIONS HAVING IMPROVED FLOWABILITY AND A HIGH HEAT DEFLECTION TEMPERATURE

(71) Applicant: Covestro Deutschland AG, Leverkusen (DE)

(72) Inventors: ROLF WEHRMANN, Krefeld (DE); Helmut Werner HEUER, Leverkusen (DE); Anke BOUMANS, Goch (DE)

(21) Appl. No.: 15/742,620

(22) PCT Filed: Jul. 5, 2016
(86) PCT No.: PCT/EP2016/065833

§ 371 Date: Jan. 8, 2018

(30) Foreign Application Priority Data
Jul. 8, 2015 (EP) 15175791.1

(51) Int. Cl. C08K 5/103; C08L 69/00; C08L 51/08; C08L 51/04; C08F 255/10

(52) U.S. Cl. CPC C08K 5/103; C08L 69/00; C08L 51/08; C08K 5/005; C08F 255/10; C08L 2201/08; C08L 51/04

(57) ABSTRACT

The present invention relates to the use of diglycerol esters to increase the flowability of impact-modified polycarbonate-containing compositions, without adverse effect on mechanical and thermal properties. Melt viscosities and melt volume flow rates are improved. In comparison with conventional flow improvers moreover smaller quantities of diglycerol esters are sufficient to achieve the desired flow improvement.

The present invention relates to impact-modified polycarbonate compositions with high flowability and good heat resistance.

Compositions of the invention are suitable for the use for the production of mouldings, in particular of housing parts in the EE sector and IT sector (EE: electrical/electronics, IT: information technology), e.g. for electrical housings/switchboxes or for frames of LCD/LED display screens, or else for housing parts of mobile communications transmission devices such as smartphones, tablets, ultrabooks, notebooks or laptops, or else for navigation devices, smartwatches or heart-frequency meters, or else electrical applications in thin-wall designs, e.g. household and industrial networking units and smart meter housing components or chocolate moulds.

The flowability of impact-modified polycarbonates can be improved by reducing the molecular weight of the polycarbonate matrix. However, this leads directly to poorer mechanical and thermal properties.

BDP (bisphenol A diphosphate) is also used conventionally for flow improvement, and specifically in quantities of up to more than 10% by weight in order to achieve the desired effect. However, this markedly reduces heat resistance. A small flow improvement is also brought about by relatively high quantities of fatty acid esters, for example PETS.

It was an object of the present invention to provide impact-modified polycarbonate compositions with a combination of improved flowability with substantial retention of mechanical and thermal properties, without the disadvantages of the compositions known from the prior art, e.g. inadequate flow behaviour during processing.

Surprisingly, it has now been found that this object is achieved via a composition comprising
A) from 80% by weight to 99% by weight of polycarbonate,
B) from 0.01% by weight to 3.0% by weight of at least one flow aid selected from the group of the diglycerol esters,
C) from 0.2% by weight to 7% by weight of an impact modifier,
D) from 0.0% by weight to 1.0% by weight of a heat stabilizer,
E) from 0.0% by weight to 10.0% by weight of one or more other additives,
where the composition is free from flame retardant.

Compositions preferred according to the invention are free from boron nitride and/or free from glass fibres, carbon fibres and carbon nanotubes, preferably free from boron nitride and from glass fibres, carbon fibres and carbon nanotubes.

Particularly preferred compositions comprise no other components at all; instead, components A) to E) give a total of 100% by weight.

Preferred compositions of the invention are those consisting of
A) from 80% by weight to 97% by weight of polycarbonate,
B) from 0.2% by weight to 2.0% by weight of at least one flow aid selected from the group of the diglycerol esters,
C) from 0.2% by weight to 7% by weight of an impact modifier,
D) from 0.0% by weight to 1.0% by weight of a heat stabilizer,
E) from 0.0% by weight to 10% by weight of one or more other additives selected from the group consisting of mould-release agents, antioxidants, UV absorbers, antistatic agents, colourants, carbon black, dyes, titanium dioxide, silicates, talc and/or barium sulphate.

Surprisingly, even relatively small quantities of the diglycerol ester are sufficient to provide a noticeable flowability improvement. The corresponding effect on thermal properties, for example dimensional stability under heat, is small.

The compositions of the invention feature good mechanical properties, in particular good low-temperature toughness, and very good rheology (free-flowing) and high dimensional stability under heat values (Vicat temperature).

Preference is given according to the invention to those compositions that also comprise, alongside the impact modifier, at least one additive from the group of the mould-release agents or heat stabilizers.

The individual constituents of the compositions of the invention are explained in more detail below:

Component A

For the purposes of the present invention, polycarbonates are either homopolycarbonates or copolycarbonates; the polycarbonates can, as is known, be linear or branched. According to the invention it is also possible to use mixtures of polycarbonates.

The polycarbonates are produced in a known manner from diphenols, carbonic acid derivatives, and optionally chain terminators and branching agents.

Details of the production of polycarbonates have been set out in many patent specifications during the last approximately 40 years. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 1, Second Edition, 1988, pages 648-718, and finally to U. Grigo, K. Kirchner and P. R. Müller “Polycarbonate [Polycarbonates]” in Becker/Braun, Kunststoff-Handbuch [Plastics handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117-299.

Aromatic polycarbonates are produced by way of example via reaction of diphenols with carbonyl halides, preferably phosgene, and/or with aromatic diacyl dihalides, preferably benzenedicarbonyl dihalides, by the interfacial process, optionally with use of chain terminators and optionally with use of trifunctional or more than trifunctional branching agents. Production via a melt polymerization process via reaction of diphenols with by way of example diphenyl carbonate is likewise possible.

Suitable diphenols for producing polycarbonates are by way of example hydroquinone, resorcinol, dihydroxybiphenyls, bis(hydroxyphenyl)alkanes, bis(hydroxyphenyl) cycloalkanes, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides, α,α′-bis(hydroxyphenyl)diisopropylbenzenes, phthalimidines derived from isatin derivatives or from phenolphthalein derivatives, and also the related ring-alkylated, ring-arylated and ring-halogenated compounds.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described by way of example in U.S. Pat. No. 3,028,635, U.S. Pat. No. 2,999,825, U.S. Pat. No. 3,148,172, U.S. Pat. No. 2,991,273, U.S. Pat. No. 3,271,367, U.S. Pat. No. 4,982,014 and U.S. Pat. No. 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates only one diphenol is used and in the case of copolycarbonates two or more diphenols are used.

Examples of suitable carbonic acid derivatives are phosgene and diphenyl carbonate.

Suitable chain terminators that may be used in the production of polycarbonates are monophenols. Examples of suitable monophenols are phenol itself, alkylphenols such as cresols, p-tert-butylphenol, cumylphenol and mixtures of these.

Preferred chain terminators are phenols mono- or polysubstituted with linear or branched, preferably unsubstituted C₁ to C₃₀ alkyl moieties or with tert-butyl. Particularly preferred chain terminators are phenol, cumylphenol and/or p-tert-butylphenol.

The quantity of chain terminator to be used is preferably from 0.1 to 5 mol %, based on mole of diphenols respectively used. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The quantity of the branching agents optionally to be used is preferably from 0.05 mol % to 2.00 mol %, based on moles of diphenols respectively used.

The branching agents can either be used as initial charge with the diphenols and the chain terminators in the aqueous alkaline phase or added after dissolution in an organic solvent before the phosgenation procedure. In the case of the transesterification process the branching agents are used together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

By way of example, in the case of glass-fibre-filled compositions it is preferable to use a mixture of the aromatic polycarbonates A1 and A2 with the following properties:

The quantity of the aromatic polycarbonate A1, based on the total quantity of polycarbonate, is from 25.0 to 85.0% by weight, preferably from 28.0 to 84.0% by weight, particularly preferably from 30.0 to 83.0% by weight, where this aromatic polycarbonate is based on bisphenol A with a preferred melt volume flow rate MVR of from 7 to 15 cm³/10 min, more preferably with a melt volume flow rate MVR of from 8 to 12 cm³/10 min and particularly preferably with a melt volume flow rate MVR of from 8 to 11 cm³/10 min, determined in accordance with ISO 1133 (test temperature 300° C., mass 1.2 kg, DIN EN ISO 1133-1:2012-03).

The quantity of the pulverulent aromatic polycarbonate A2, based on the total quantity of polycarbonate, is from 3.0 to 12.0% by weight, preferably from 4.0 to 11.0% by weight, particularly preferably from 4.0 to 10.0% by weight, where this aromatic polycarbonate is preferably based on bisphenol A with a preferred melt volume flow rate MVR of from 3 to 8 cm³/10 min, more preferably with a melt volume flow rate MVR of from 4 to 7 cm³/10 min and particularly preferably with a melt volume flow rate MVR of 6 cm³/10 min, determined in accordance with ISO 1133 (test temperature 300° C., mass 1.2 kg, DIN EN ISO 1133-1:2012-03).

The quantity of aromatic polycarbonate used in compositions of the invention is from 80 to 99% by weight, very particularly preferably from 94 to 97% by weight.

Component B

The flow aids D used are esters of carboxylic acids with diglycerol. Esters based on various carboxylic acids are suitable here. The esters may also be based on different isomers of diglycerol. It is possible to use not only monoesters but also polyesters of diglycerol. It is also possible to use mixtures instead of pure compounds.

Diglycerol isomers forming the basis for the diglycerol esters used according to the invention are the following:

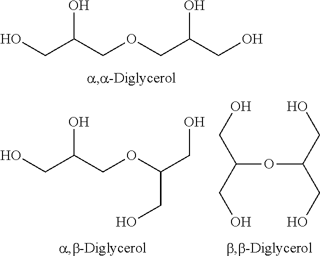

Mono- or polyesterified isomers of these formulae can be used for the diglycerol esters used according to the invention. Mixtures that can be used as flow aids are composed of the diglycerol starting materials and of ester products derived therefrom, for example with the molar masses 348 g/mol (monolauryl ester) or 530 g/mol (dilauryl ester).

The diglycerol esters present in the composition according to the invention preferably derive from saturated or unsaturated monocarboxylic acids with chain length from 6 to 30 carbon atoms. Examples of suitable monocarboxylic acids are caprylic acid (C₇H₁₅COOH, octanoic acid), capric acid (C₉H₁₉COOH, decanoic acid), lauric acid (C₁₁H₂₃COOH, dodecanoic acid), myristic acid (C₁₃H₂₇COOH, tetradecanoic acid), palmitic acid (C₁₅H₃₁COOH, hexadecanoic acid), margaric acid (C₁₆H₃₃COOH, heptadecanoic acid), stearic acid (C₁₇H₃₅COOH, octadecanoic acid), arachidic acid (C₁₉H₃₉COOH, eicosanoic acid), behenic acid (C₂₁H₄₃COOH, docosanoic acid), lignoceric acid (C₂₃H₄₇COOH, tetracosanoic acid), palmitoleic acid (C₁₅H₂₉COOH, (9Z)-hexadeca-9-enoic acid), petroselic acid (C₁₇H₃₃COOH, (6Z)octadeca-6-enoic acid), elaidic acid (C₁₇H₃₃COOH, (9E)octadeca-9-enoic acid), linoleic acid (C₁₇H₃₁COOH, (9Z,12Z)-octadeca-9,12-dienoic acid), alpha- or gammalinolenic acid (C₁₇H₂₉COOH, (9Z,12Z,15Z)-octadeca-9,12,15-trienoic acid and (6Z,9Z,12Z)-octadeca-6,9,12-trienoic acid), arachidonic acid (C₁₉H₃₁COOH, (5Z,8Z,11Z,14Z)-eicosa-5,8,11,14-tetraenoic acid), timnodonic acid (C₁₉H₂₉COOH, (5Z,8Z,11Z,14Z,17Z)-eicosa-5,8,11,14,17-pentaenoic acid) and cervonic acid (C₂₁H₃₁COOH, (4Z,7Z,10Z,13Z,16Z,19Z)-docosa-4,7,10,13,16,19-hexaenoic acid). Particular preference is given to lauric acid, palmitic acid and/or stearic acid.

It is particularly preferable that at least one ester of the formula (I) is present as diglycerol ester

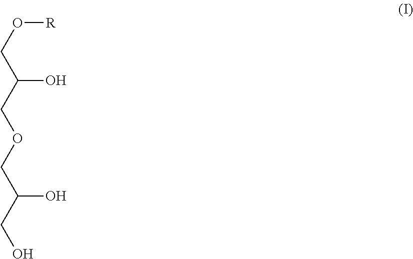

where R═COCₙH₂ₙ₊₁ and/or R═COR′,
where n is an integer and where R′ is a branched alkyl moiety or a branched or unbranched alkenyl moiety and CₙH₂ₙ₊₁ is an aliphatic, saturated linear alkyl moiety.

It is preferable here that n is an integer from 6 to 24, examples of CₙH₂n+₁ therefore being n-hexyl, n-heptyl, n-octyl, n-nonyl, n-decyl, n-dodecyl, n-tridecyl, n-tetradecyl, n-hexadecyl or n-octadecyl. It is more preferable that n is from 8 to 18, particularly from 10 to 16, very particularly 12 (diglycerol monolaurate isomer with molar mass 348 g/mol, which is particularly preferred as main compound in a mixture). According to the invention, it is also preferable that the abovementioned ester groups are present when the other isomers of diglycerol are used.

A mixture of various diglycerol esters can therefore also be used.

The HLB value of diglycerol esters preferably used is at least 6, particularly from 6 to 12, where the HLB value is defined as the “hydrophilic-lipophilic balance”, calculated as follows in accordance with the Griffin method:

HLB=20×(1−M_{lipophilic}/M)

where M_{lipophilic} is the molar mass of the lipophilic fraction of the diglycerol ester and M is the molar mass of the diglycerol ester.

The quantity of diglycerol ester is from 0.01 to 3.0% by weight, preferably from 0.20 to 2.0% by weight, more preferably from 0.15 to 1.50% by weight, still more preferably from 0.10 to 1.0% by weight, very particularly preferably from 0.10 to 0.5% by weight.

### Component C

Component C is at least one impact modifier.

It is preferable that component C is one or more graft polymers of
C.1 from 5 to 95% by weight, preferably from 30 to 90% by weight, of at least one vinyl monomer on
C.2 from 95 to 5% by weight, preferably from 70 to 10% by weight, of at least one graft base selected from the group consisting of diene rubbers, EP(D)M rubbers (i.e. rubbers based on ethylene/propylene and optionally diene), acrylate rubbers, polyurethane rubbers, silicone rubbers, silicone acrylate rubbers, chloroprene rubbers and/or ethylene/vinyl acetate rubbers.

It is preferable that the median particle size (dso value) of the graft base C.2 is from 0.05 to 10 μm, with preference from 0.1 to 5 μm, particularly from 0.2 to 0.4 μm.

Monomers C.1 are preferably mixtures of
C.1.1 from 50 to 99 parts by weight of vinylaromatics and/or ring-substituted vinylaromatics (such as styrene, α-methylstyrene, p-methylstyrene, pchlorostyrene) and/or C1- to C8-alkyl (meth)acrylates, such as methyl methacrylate, ethyl methacrylate), and
C.1.2 from 1 to 50 parts by weight of vinyl cyanides (unsaturated nitriles, such as acrylonitrile and methacrylonitrile) and/or C1- to C8-alkyl (meth)acrylates, such as methyl methacrylate, n-butyl acrylate, tert-butyl acrylate, and/or derivatives (such as anhydrides and imides) of unsaturated carboxylic acids, for example maleic anhydride and N-phenylmaleimide.

Preferred monomers C.1.1 are those selected from at least one of the monomers styrene, α-methylstyrene and methyl methacrylate, and preferred monomers C.1.2 are those selected from at least one of the monomers acrylonitrile, maleic anhydride and methyl methacrylate. Particularly preferred monomers are C.1.1 styrene and C.1.2 acrylonitrile.

Preferred graft bases C.2 are silicone acrylate rubbers, diene rubbers (for example those based on butadiene and isoprene) and mixtures of diene rubbers. For the purposes of the invention, the term diene rubbers also covers copolymers of diene rubbers or of mixtures of these with other copolymerizable monomers (e.g. as per C.1.1 and C.1.2).

The glass transition temperature of the graft bases C.2 is generally <10° C., preferably <0° C., particularly preferably <−10° C.

The gel content of the graft base C.2 is preferably at least 20% by weight, and in the case of graft bases C.2 produced by the emulsion polymerization process preferably at least 40% by weight (measured in toluene).

It is preferable that the graft polymer made of components C.1 and C.2 has a core-shell structure where component C.1 forms the shell and component C.2 forms the core; (see by way of example Ullmann's Encyclopedia of Industrial Chemistry, VCH-Verlag, Vol. A21, 1992, page 635 and page 656).

The graft copolymers C are produced by free-radical polymerization, for example by emulsion, suspension, solution or bulk polymerization, preferably by emulsion or bulk polymerization.

Because, as is known, the graft monomers are not necessarily entirely grafted onto the graft base during the grafting reaction, the expression graft polymers C according to the invention also covers products which are obtained via (co)polymerization of the graft monomers in the presence of the graft base and which arise concomitantly during work-up.

Suitable acrylate rubbers as per C.2 of the polymers C are preferably polymers of alkyl acrylates, if appropriate with up to 40% by weight, based on C.2, of other polymerizable, ethylenically unsaturated monomers. Among the preferred polymerizable acrylic esters are C1- to C8-alkyl esters, such as methyl, ethyl, butyl, n-octyl and 2-ethylhexyl esters; haloalkyl esters, preferably halo-C1- to C8-alkyl esters, such as chloroethyl acrylate, and also mixtures of these monomers.

Monomers having more than one polymerizable double bond can be copolymerized for crosslinking purposes. Preferred examples of crosslinking monomers are esters of unsaturated monocarboxylic acids having from 3 to 8 carbon atoms and of unsaturated monohydric alcohols having from 3 to 12 carbon atoms, or of saturated polyols having from 2 to 4 OH groups and from 2 to 20 carbon atoms, e.g. ethylene glycol dimethacrylate, allyl methacrylate; polyunsaturated heterocyclic compounds, e.g. trivinyl and triallyl cyanurate; polyfunctional vinyl compounds, such as di- and trivinylbenzenes; and also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydros-triazine, triallylbenzenes. The quantity of the crosslinked monomers is preferably from 0.02 to 5% by weight, in particular from 0.05 to 2% by weight, based on the graft base C.2. In the case of cyclic crosslinking monomers having at least three ethylenically unsaturated groups, it is advantageous to restrict the quantity to less than 1% by weight of the graft base C.2.

Examples of preferred “other” polymerizable, ethylenically unsaturated monomers which can optionally serve alongside the acrylic esters for production of the graft base C.2 are acrylonitrile, styrene, α-methylstyrene, acrylamides, vinyl C₁-C₆-alkyl ethers, methyl methacrylate, butadiene. Preferred acrylate rubbers as graft base C.2 are emulsion polymers having at least 60% by weight gel content.

Suitable silicone rubbers as per C.2 can be produced via emulsion polymerization, as described by way of example in U.S. Pat. No. 2,891,920 and U.S. Pat. No. 3,294,725. Other suitable graft bases as per C.2 are silicone rubbers having graft-active sites, as described in DE-A1 3 704 657, DE-A1 3 704 655, DE-A1 3 631 540 and DE-A1 3 631 539.

Silicone acrylate rubbers are also suitable as graft bases C.2 according to the invention. The said silicone acrylate rubbers are composite rubbers having graft-active sites comprising from 10 to 90% by weight of silicone rubber content and from 90 to 10% by weight of polyalkyl (meth)acrylate rubber content, where the two rubber components mentioned penetrate into one another in the composite rubber in such a way that they cannot be substantially separated from one another. If the content of the silicone rubber component in the composite rubber is too high, the finished resin compositions have disadvantageous surface properties and are less easy to colour. If, in contrast, the content of the polyalkyl (meth)acrylate rubber component in the composite rubber is too high, the impact resistance of the finished resin composition is adversely affected.

Silicone acrylate rubbers are known and are described by way of example in U.S. Pat. No. 5,807,914, EPA2 430134 and U.S. Pat. No. 4,888,388. It is preferable to use a graft polymer produced by emulsion polymerization where C.1 is methyl methacrylate and C.2 is silicone acrylate composite rubber.

The gel content of the graft base C.2 is determined at 25° C. in a suitable solvent (M. Hoffmann, H. Kremer, R. Kuhn, Polymeranalytik I und II [Polymer analysis I and II], Georg Thieme-Verlag, Stuttgart 1977).

The median particle size dso is the diameter above and below which 50% by weight of the particles respectively lie. It can be determined by using ultracentrifuge measurement (W. Scholtan, H. Lange, Kolloid, Z. und Z. Polymere 250 (1972), 782-796).

Glass transition temperature is determined by using differential scanning calorimetry (DSC) in accordance with the standard DIN EN 61006 (DIN EN 61006:2004-11) at heating rate 10 K/min, where T_{g} is defined as midpoint temperature (tangent method).

### Component D

Heat stabilizers preferably used are triphenylphosphine, tris(2,4-di-tert-butylphenyl) phosphite (Irgafos® 168), tetrakis(2,4-di-tert-butylphenyl)-[1,1-biphenyl]-4,4′-diyl bisphosphonite, trisisooctyl phosphate, octadecyl-3-(3,5-di-tert-butyl-4-hydroxyphenyl) propionate (Irganox® 1076), bis(2,4-dicumylphenyl) pentaerythritol diphosphite (Doverphos® S-9228-PC) and/or bis(2,6-di-tert-butyl-4-methylphenyl)pentaerythritol diphosphite (ADK STAB PEP-36). Insofar as a heat stabilizer is used, it is used alone or in a mixture (e.g. Irganox® B900 (mixture of Irgafos® 168 and Irganox® 1076 in the ratio 1:3) or Doverphos® S-9228-PC with Irganox® B900 or, respectively, Irganox® 1076). It is particularly preferable to use triisooctyl phosphate.

Insofar as a heat stabilizer is used, the quantity of heat stabilizer usually used is from 0.001 to 1.0% by weight. Quantities preferably used of component D are from 0.003 to 0.5% by weight, particularly from 0.1 to 0.2% by weight.

### Component E

Materials optionally additionally present are up to 10.0% by weight, preferably from 0.10 to 8.0% by weight, particularly preferably from 0.2 to 3% by weight, of other conventional additives (“other additives”). The group of the other additives comprises by way of example mould-release agents and/or colourants, but no heat stabilizers because these have already been described as component D. “Other additives” also exclude flow aids from the group of the diglycerol esters because these have already been included as component B. In particular, the group of the other additives also excludes boron nitride, glass fibres, carbon fibres and carbon nanotubes.

These additives usually added in polycarbonates are in particular the following materials described in EP-A 0 839 623, WO-A 96/15102, EP-A 0 500 496 or “Plastics Additives Handbook”, Hans Zweifel, 5th Edition 2000, Hanser Verlag, Munich: antioxidants, UV absorbers, antistatic agents, colourants such as pigments, including inorganic pigments, carbon black and/or dyes, inorganic fillers such as titanium dioxide, silicates, talc and/or barium sulphate in the quantities usual for polycarbonate. These additives can be added individually or else in a mixture.

Preferred additives are specific UV absorbers which have minimal transmittance below 400 nm and maximal transmittance above 400 nm. Particularly suitable ultraviolet absorbers for use in the composition of the invention are benzotriazoles, triazines, benzophenones and/or arylated cyanoacrylates.

Among these are hydroxybenzotriazoles such as 2-(3′,5′-bis(1,1-dimethylbenzyl)-2′-hydroxyphenyl)benzotriazole (Tinuvin® 234, BASF, Ludwigshafen), 2-(2′-hydroxy-5′-(tert-octyl)phenyl)benzotriazole (Tinuvin® 329, BASF, Ludwigshafen), bis(3-(2H-benzotriazolyl)-2-hydroxy-5-tert-octyl)methane (Tinuvin® 360, BASF, Ludwigshafen) and 2-(4,6-diphenyl-1,3,5-triazin-2-yl)-5-(hexyloxy)phenol (Tinuvin® 1577, BASF, Ludwigshafen), and also benzophenones such as 2,4-dihydroxybenzophenone (Chimasorb® 22, BASF, Ludwigshafen) and 2-hydroxy-4-(octyloxy)benzophenone (Chimassorb® 81, BASF, Ludwigshafen), 2,2-bis[[(2-cyano-1-oxo-3,3-diphenyl-2-propenyl) oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (Tinuvin® 1600, BASF, Ludwigshafen), tetraethyl 2,2′-(1,4-phenylenedimethylidene)bismalonate (Hostavin® B-Cap, Clariant AG) and N-(2-ethoxyphenyl)-N′(2-ethylphenyl)ethanediamide (Tinuvin® 312, CAS No. 23949-66-8, BASF, Ludwigshafen).

Particularly preferred UV absorbers are Tinuvin® 360, Tinuvin® 329 and/or Tinuvin® 312, very particular preference being given to Tinuvin® 329 and Tinuvin® 312.

It is also possible to use mixtures of these ultraviolet absorbers.

It is preferable that the composition comprises a quantity of up to 0.8% by weight, preferably from 0.05% by weight to 0.5% by weight, more preferably from 0.1% by weight to 0.4% by weight, of ultraviolet absorbers, based on the entire composition.

It is preferable that the composition comprises at least one mould-release agent or one heat stabilizer.

The polymer compositions of the invention, comprising components A to E, optionally without D and/or E, are produced by familiar incorporation processes via combination, mixing and homogenization of the individual constituents, and in particular the homogenization here preferably takes place in the melt with exposure to shear forces. Powder premixes can optionally be used for the combination and mixing before melt homogenization.

It is also possible to use premixes made of pellets or of pellets and powders with components B to E.

It is also possible to use premixes produced from solutions of the mixture components in suitable solvents, where homogenization is optionally carried out in solution and the solvent is then removed.

In particular, components B to E of the compositions of the invention can be introduced here via known processes or in the form of masterbatch into the polycarbonate.

It is preferable to use masterbatches to introduce components B to E, individually or in a mixture.

Mixing and homogenization of the composition of the invention here can be carried out in conventional devices such as screw-based extruders (e.g. TSE twin-screw extruders) kneaders, Brabender mixers or Banbury mixers, and the composition can then be extruded. The extrudate can be cooled and comminuted. It is also possible to premix individual components and then to add the remaining starting materials individually and/or likewise in a mixture.

It is also possible to combine and mix a premix in the melt in the plastifying unit of an injection-moulding machine. In this case, the following step converts the melt directly into a moulding.

Production of the moulded plastics parts is preferably achieved via injection moulding.

Compositions of the invention in the form of polycarbonate compositions are suitable for the production of multilayer systems. The polycarbonate composition of the invention is applied here in one or more layers to a moulded article made of a plastic. Application can take place simultaneously with or immediately after the shaping of the moulding, for example via foil insert moulding, coextrusion or multicomponent injection moulding. However, application can also take place onto the finished main moulded body, e.g. via lamination with a film or overmoulding of an existing moulding or via coating from a solution.

Compositions of the invention are suitable for the production of frame components in the EE (electrical/electronics) sector and IT sector. Examples of these applications are display screens or housings, for example for ultrabooks, or frames for LED display technologies, e.g. OLED displays or LCD displays, or else for electronic ink devices. Other fields of application are housing parts of mobile communications transmission devices, for example smartphones, tablets, ultrabooks, notebooks or laptops, and also navigation devices, smartwatches or heart-frequency meters, and also electrical applications in thin-wall designs, e.g. domestic and industrial networking units, and smart meter housing components, or chocolate moulds or other food-contact applications.

### EXAMPLES

### 1. Description of Raw Materials and Test Methods

The polycarbonate compositions of the invention relating to the following examples were produced in a ZE 25 extruder from Berstorff with throughput 10 kg/h. Melt temperature was 275° C.

Component A-1: Linear polycarbonate based on bisphenol A with melt volume flow rate MVR 12.5 cm³/10 min (in accordance with ISO 1133 at test temperature 300° C. with 1.2 kg load, DIN EN ISO 1133-1:2012-03).

Component A-2: Linear polycarbonate based on bisphenol A with melt volume flow rate MVR 9.5 cm³/10 min (in accordance with ISO 1133 at test temperature 300° C. with 1.2 kg load, DIN EN ISO 1133-1:2012-03).

Component A-3: Linear polycarbonate based on bisphenol A with melt volume flow rate MVR 16.5 cm³/10 min (in accordance with ISO 1133 at test temperature 250° C. with 2.16 kg load, DIN EN ISO 1133-1:2012-03).

Component A-4: Linear polycarbonate in powder form based on bisphenol A with melt volume flow rate MVR 19 cm³/10 min (in accordance with ISO 1133 at test temperature 300° C. with 1.2 kg load, DIN EN ISO 1133-1:2012-03).

Component A-5: Linear polycarbonate in powder form based on bisphenol A with melt volume flow rate MVR 6 cm³/10 min (in accordance with ISO 1133 at test temperature 300° C. with 1.2 kg load, DIN EN ISO 1133-1:2012-03).

Component B-1: Pentaerythritol tetrastearate (PETS) from Emery Oleochemicals.

Component B-2: Poem DL-100 (diglycerol monolaurate) from Riken Vitamin as flow aid.

Component C-1: MBS impact modifier (methacrylatebutadiene-styrene) Paraloid® EXL2650 from DOW.

Component C-2: Acrylic core-shell impact modifier based on butyl acrylate rubber; Paraloid® EXL2300 from DOW.

Component C-3: Durastrength® D440 acrylic impact modifier from Arkema.

Component C-4: Metablen S-2001 silicone acrylate rubber from Mitsubishi Rayon.

Component D: Triisooctyl phosphate (TOF) from Lanxess AG.

Component Z: Hostanoxs PEPQ from Clariant as antioxidant.

Charpy notched impact resistance was measured at room temperature in accordance with ISO 7391/180A on single-side-injected test specimens measuring 80 mm×10 mm×3 mm.

Vicat softening point VST/B50 was determined as a measure of heat resistance in accordance with ISO 306 on test samples measuring 80 mm×10 mm×4 mm with 50 N ram loading and heating rate 50° C./h with a Coesfeld Eco 2920 from Coesfeld Material test.

Melt volume flow rate (MVR) was determined in accordance with ISO 1133 (at test temperature 300° C., mass 1.2 kg, DIN EN ISO 1133-1:2012-03) with a Zwick 4106 from Zwick Roell.

Melt viscosities were determined in accordance with ISO 11443 (cone-and-plate arrangement, ISO 11443:2014-04).

TABLE 1

| Formulation | | CE1 | IE1 | IE2 |
|---|---|---|---|---|
| A-1 | [% by wt.] | 93.00 | 93.00 | 93.00 |
| A-5 | [% by wt.] | 3.40 | 3.79 | 3.59 |
| C-1 | [% by wt.] | 3.00 | 3.00 | 3.00 |
| B-1 | [% by wt.] | 0.60 | — | — |
| B-2 | [% by wt.] | — | 0.20 | 0.40 |
| D | [% by wt.] | — | 0.01 | 0.01 |
| MVR | [ml/10 min] | 10.2 | 15.6 | 26.3 |
| IMVP20′ | [ml/10 min] | 11.1 | 17.2 | 27.0 |
| Delta | | 0.9 | 1.6 | 0.7 |
| MVR/ | | | | |
| IMVR20′ | | | | |
| Vicat VST | [° C.] | 142.9 | 143.9 | 141.2 |
| B50 | | | | |
| Notched | | | | |
| impact | | | | |
| resistance | | | | |
| ISO | | | | |
| 7391, 3 mm | | | | |
| 23° C. | [kJ/m²] | 60 | 58 | 52 |
| | | tough | tough | tough |
| −20° C. | [kJ/m²] | 54 | 52 | 9 × 45 |
| | | tough | tough | tough |
| | | | | 1 × 24 |
| | | | | brittle |
| −30° C. | [kJ/m²] | — | — | 2 × 33 |
| | | | | tough |
| | | | | 8 × 25 |
| | | | | brittle |
| −40° C. | [kJ/m²] | 50 | 47 | 23 |
| | | tough | tough | brittle |

Inventive Examples IE1 and IE2 exhibit markedly higher MVR values than Comparative Example CE1 which does not comprise the diglycerol ester. It can moreover be seen that the relatively small quantities of diglycerol ester in Inventive Examples IE1 and IE2 give markedly better flowability than the large quantity of PETS (component B-1) in CE1. The Vicat points remain at a high level.

TABLE 2

| Formulation | | CE2 | IE3 | IE4 | IE5 |
|---|---|---|---|---|---|
| A-2 | [% by wt.] | 93.00 | 93.00 | 93.00 | 93.00 |
| A-5 | [% by wt.] | 2.89 | 2.79 | 2.69 | 2.59 |
| E | [% by wt.] | 0.10 | 0.10 | 0.10 | 0.10 |
| C-2 | [% by wt.] | 4.00 | 4.00 | 4.00 | 4.00 |
| B-2 | [% by wt.] | | 0.10 | 0.20 | 0.30 |
| D | [% by wt.] | 0.01 | 0.01 | 0.01 | 0.01 |
| MVR | [ml/10 min] | 8.3 | 16.2 | 45.4 | 45.6 |
| IMVR20′ | [ml/10 min] | 8.5 | 17.6 | 40.8 | 47.0 |
| Delta | | 0.2 | 1.4 | −4.6 | 1.4 |
| MVR/ | | | | | |
| IMVR20′ | | | | | |
| Vicat VST | [° C.] | 144.5 | 143.8 | 143.7 | 142.3 |
| B50 | | | | | |
| Melt | | | | | |
| viscosity | | | | | |
| at 280° C. | | | | | |
| eta 50 | [Pa · s] | 912 | 905 | 669 | 576 |
| eta 100 | [Pa · s] | 862 | 833 | 617 | 569 |
| eta 200 | [Pa · s] | 785 | 759 | 591 | 524 |
| eta 500 | [Pa · s] | 617 | 600 | 488 | 449 |
| eta 1000 | [Pa · s] | 451 | 444 | 382 | 350 |
| eta 1500 | [Pa · s] | 358 | 354 | 319 | 290 |
| eta 5000 | [Pa · s] | 167 | 158 | 149 | 137 |
| Melt | | | | | |
| viscosity | | | | | |
| at 300° C. | | | | | |
| eta 50 | [Pa · s] | 467 | 414 | 316 | |
| eta 100 | [Pa · s] | 458 | 408 | 293 | |
| eta 200 | [Pa · s] | 434 | 393 | 280 | 277 |
| eta 500 | [Pa · s] | 374 | 341 | 267 | 250 |
| eta 1000 | [Pa · s] | 303 | 281 | 225 | 217 |
| eta 1500 | [Pa · s] | 255 | 239 | 201 | 192 |
| eta 5000 | [Pa · s] | 125 | 120 | 108 | 103 |
| Melt | | | | | |
| viscosity | | | | | |
| at 320° C. | | | | | |
| eta 50 | [Pa · s] | 254 | 259 | 195 | |
| eta 100 | [Pa · s] | 243 | 254 | 193 | |
| eta 200 | [Pa · s] | 238 | 253 | 187 | |
| eta 500 | [Pa · s] | 216 | 231 | 174 | 141 |
| eta 1000 | [Pa · s] | 185 | 198 | 156 | 123 |
| eta 1500 | [Pa · s] | 162 | 175 | 140 | 113 |
| eta 5000 | [Pa · s] | 80 | 98 | 88 | 77 |
| Notched | | | | | |
| impact | | | | | |
| resistance | | | | | |
| ISO | | | | | |
| 7391, 3 mm | | | | | |
| 23° C. | [kJ/m²] | 64 | 63 | 64 | 63 |
| | | tough | tough | tough | tough |
| −20° C. | [kJ/m²] | 57 | 56 | 57 | 57 |
| | | tough | tough | tough | tough |
| −30° C. | [kJ/m²] | 56 | 54 | 9 × 64 | 55 |
| | | tough | tough | tough | tough |
| | | | | 1 × 26 | |
| | | | | brittle | |
| −40° C. | [kJ/m²] | 21 | 19 | 20 | 18 |
| | | brittle | brittle | brittle | brittle |

Inventive Examples IE3 to IE5 exhibit markedly higher MVR values than Comparative Example CE2 which does not comprise the diglycerol ester. There is moreover a marked reduction in melt viscosities across the shear range tested at all test temperatures. The Vicat points remain at a high level.

TABLE 3

| Formulation | | CE3 | CE4 | IE6 | IE7 |
|---|---|---|---|---|---|
| A-3 | [% by wt.] | 70.00 | 70.00 | 70.00 | 70.00 |
| A-1 | [% by wt.] | 23.00 | 23.00 | 23.00 | 23.00 |
| A-4 | [% by wt.] | 4.59 | 4.99 | 4.89 | 4.79 |
| B-1 | [% by wt.] | 0.40 | | | |
| C-3 | [% by wt.] | 2.00 | 2.00 | 2.00 | 2.00 |
| B-2 | [% by wt.] | | | 0.10 | 0.20 |
| D | [% by wt.] | 0.01 | 0.01 | 0.01 | 0.01 |
| MVR | [ml/10 min] | 39.9 | 36.9 | 49.9 | 61.2 |
| IMVR20′ | [ml/10 min] | 43.5 | 36.1 | 51.3 | 64.3 |
| Delta | | 3.6 | −0.8 | 1.4 | 3.1 |
| MVR/ | | | | | |
| IMVR20′ | | | | | |
| Vicat VST | [°C.] | 141.8 | 143.8 | 143.3 | 142 |
| B50 | | | | | |
| Notched | | | | | |
| impact | | | | | |
| resistance | | | | | |
| ISO | | | | | |
| 7391, 3 mm | | | | | |
| 23° C. | [kJ/m²] | 49 | 50 | 48 | 50 |
| | | tough | tough | tough | tough |
| 10° C. | [kJ/m²] | 46 | — | | 46 |
| | | tough | | | tough |
| 0° C. | [kJ/m²] | 5 × 44 | 44 | 44 | 7 × 43 |
| | | tough | tough | tough | tough |
| | | 5 × 25 | | | 3 × 27 |
| | | brittle | | | brittle |
| −10° C. | [kJ/m²] | 1 × 31 | 22 | 1 × 33 | 19 |
| | | tough | brittle | tough | brittle |
| | | 9 × 19 | | 9 × 21 | |
| | | brittle | | brittle | |
| −20° C. | [kJ/m²] | 17 | 16 | 16 | 16 |
| | | brittle | brittle | brittle | brittle |

Inventive Examples IE6 and IE7 exhibit markedly higher MVR values than Comparative Examples CE3 and CE4 which do not comprise the glycerol ester. There is moreover a marked reduction in melt viscosities across the shear range tested at all test temperatures. The Vicat points remain at a high level.

TABLE 4

| Formulation | | CE5 | CE6 | IE8 | IE9 | IE10 |
|---|---|---|---|---|---|---|
| A-1 | [% by wt.] | 93.00 | 93.00 | 93.00 | 93.00 | 93.00 |
| A-5 | [% by wt.] | 1.40 | 2.00 | 1.90 | 1.70 | 1.50 |
| B-1 | [% by wt.] | 0.60 | | | | |
| C-4 | [% by wt.] | 5.00 | 5.00 | 5.00 | 5.00 | 5.00 |
| B-2 | [% by wt.] | | | 0.10 | 0.30 | 0.50 |
| MVR | [ml/10 min] | 11.5 | 10.9 | 11.6 | 13.8 | 14.7 |
| IMVR20′ | [ml/10 min] | 12.5 | 12.0 | 12.7 | 14.8 | 19.7 |
| Delta | | 1.0 | 1.1 | 1.1 | 1.0 | 5.0 |
| MVR/ | | | | | | |
| IMVR20′ | | | | | | |
| Vicat VST | [° C.] | 139.9 | 143.7 | 142.8 | 141.1 | 139.6 |
| B50 | | | | | | |
| Melt | | | | | | |
| viscosity | | | | | | |
| at 280° C. | | | | | | |
| eta 50 | [Pa · s] | 617 | 622 | 661 | 604 | 565 |
| eta 100 | [Pa · s] | 599 | 617 | 621 | 587 | 543 |
| eta 200 | [Pa · s] | 546 | 577 | 567 | 537 | 499 |
| eta 500 | [Pa · s] | 438 | 464 | 458 | 438 | 405 |
| eta 1000 | [Pa · s] | 338 | 361 | 356 | 341 | 318 |
| eta 1500 | [Pa · s] | 279 | 297 | 293 | 282 | 262 |
| eta 5000 | [Pa · s] | 132 | 140 | 138 | 135 | 129 |
| Melt | | | | | | |
| viscosity | | | | | | |
| at 300° C. | | | | | | |
| eta 50 | [Pa · s] | 312 | 335 | 333 | 321 | 284 |
| eta 100 | [Pa · s] | 309 | 331 | 324 | 312 | 275 |
| eta 200 | [Pa · s] | 290 | 310 | 309 | 296 | 265 |
| eta 500 | [Pa · s] | 254 | 272 | 272 | 261 | 234 |
| eta 1000 | [Pa · s] | 213 | 227 | 227 | 219 | 201 |
| eta 1500 | [Pa · s] | 186 | 198 | 198 | 191 | 174 |
| eta 5000 | [Pa · s] | 102 | 107 | 107 | 104 | 97 |
| Melt | | | | | | |
| viscosity | | | | | | |
| at 320° C. | | | | | | |
| eta 50 | [Pa · s] | 196 | 207 | 199 | 192 | 177 |
| eta 100 | [Pa · s] | 194 | 205 | 196 | 190 | 173 |
| eta 200 | [Pa · s] | 186 | 197 | 189 | 182 | 164 |
| eta 500 | [Pa · s] | 167 | 178 | 169 | 164 | 148 |
| eta 1000 | [Pa · s] | 146 | 156 | 147 | 145 | 132 |
| eta 1500 | [Pa · s] | 131 | 139 | 133 | 131 | 119 |
| eta 5000 | [Pa · s] | 80 | 84 | 81 | 80 | 75 |
| Notched | | | | | | |
| impact | | | | | | |
| resistance | | | | | | |
| ISO | | | | | | |
| 7391, 3 mm | | | | | | |
| 23° C. | [kJ/m²] | 64 | 63 | 62 | 61 | 61 |
| | | tough | tough | tough | tough | tough |
| −20° C. | [kJ/m²] | 57 | 55 | 54 | 53 | 53 |
| | | tough | tough | tough | tough | tough |
| −30° C. | [kJ/m²] | 45 | 48 | 45z | 9 × 40 | 8 × 33 |
| | | tough | tough | tough | tough | tough |
| | | | | | 1 × 28 | 2 × 27 |
| | | | | | brittle | brittle |

Inventive Examples IE8 to IE10 exhibit markedly higher MVR values than Comparative Examples CE5 and CE6 which do not comprise the glycerol ester. There is moreover a marked reduction in melt viscosities across the shear range tested at all test temperatures. It can moreover be seen that the relatively small quantities of diglycerol ester in Inventive Examples IE8 to IE10 give markedly better flowability than the large quantity of PETS (Component B-1) in CE5. The Vicat points remain at a high level.

1.-10. (canceled)

11. A composition comprising
A) from 80% by weight to 99% by weight of polycarbonate,
B) from 0.01% by weight to 3.0% by weight of at least one flow aid selected from the group of the diglycerol esters,
C) from 0.2% by weight to 7% by weight of an impact modifier,
where the composition is free from flame retardant.

12. The composition according to claim 11, characterized in that the impact modifier is one or more graft polymers of
C1) from 5 to 95% by weight of at least one vinyl monomer on
C2) from 95 to 5% by weight of at least one graft base selected from the group consisting of diene rubbers, EP(D)M rubbers, acrylate rubbers, polyurethane rubbers, silicone rubbers, silicone acrylate rubbers, chloroprene rubbers, ethylene/vinyl acetate rubbers, and combinations thereof.

13. The composition according to claim 11, characterized in that the composition is free from boron nitride.

14. The composition according to claim 11, characterized in that the composition is free from glass fibres, carbon fibres and carbon nanotubes.

15. The composition according to claim 11, characterized in that the composition comprises D) from 0.003 to 0.5% by weight of a heat stabilizer.

16. The composition according to claim 11, characterized in that from 0.2 to 1.0% by weight of diglycerol ester is present.

17. The composition according to claim 11, characterized in that an ester of the formula (I) is present as diglycerol ester 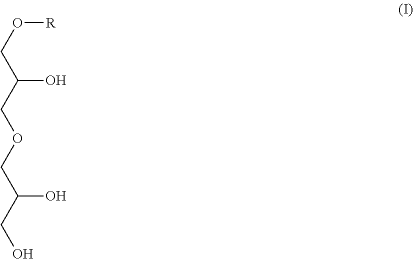
where R═COCₙH₂ₙ₊₁ and/or R═COR′,
where n is an integer and R′ is a branched alkyl moiety or a branched or unbranched alkenyl moiety and CₙH₂ₙ₊₁ is an aliphatic, saturated linear alkyl moiety.

18. The composition according to claim 11, characterized in that R═COCₙH₂ₙ₊₁, where n is an integer from 6 to 24.

19. The composition according to claim 11, characterized in that the diglycerol ester is diglycerol monolauryl ester, optionally in a mixture with other diglycerol esters.

20. The composition according to claim 11, wherein the composition comprises
A) from 80% by weight to 97% by weight of polycarbonate,
B) from 0.2% by weight to 2.0% by weight of at least one flow aid selected from the group of the diglycerol esters,
C) from 0.2% by weight to 7% by weight of an impact modifier,
D) from 0.0% by weight to 1.0% by weight of a heat stabilizer,
E) from 0.0% by weight to 10.0% by weight of one or more other additives selected from the group consisting of mold-release agents, antioxidants, UV absorbers, antistatic agents, colorants, carbon black, dyes, titanium dioxide, silicates, talc, barium sulphate, and combinations thereof.

21. The composition according to claim 11, characterized in that R═COCₙH₂ₙ₊₁, where n is an integer from 8 to 18.

22. The composition according to claim 11, characterized in that R═COCₙH₂ₙ₊₁, where n is an integer from 10 to 16.

23. The composition according to claim 11, characterized in that R═COCₙH₂ₙ₊₁, where n is 12.
